(19) United States
(12) Patent Application Publication
(10) Pub. No.: US 2020/0201368 A1
(43) Pub. Date: Jun. 25, 2020

(54) WIRELESS CLIMATE CONTROL SYSTEM

(71) Applicant: Carrier Corporation, Palm Beach Gardens, FL (US)

(72) Inventor: Brian W. Eicher, Fort Wayne, IN (US)

(21) Appl. No.: 16/638,995

(22) PCT Filed: Aug. 16, 2018
(86) PCT No.: PCT/IB2018/056191

§ 371 Date: Feb. 13, 2020

Related U.S. Application Data
(60) Provisional application No. 62/546,102, filed on Aug. 16, 2017.

(51) Int. Cl. G05D 23/19; H04L 29/08; H04W 4/70; F24F 11/56

(52) U.S. Cl. CPC G05D 23/1905; F24F 11/56; H04W 4/70; H04L 67/12

(57) ABSTRACT

A wireless climate control system including a wall control having a user interface for controlling a plurality of climate zones. Also disclosed is a wireless sensor disposed in one of the plurality of climate zones. Further disclosed is a controller in operative communication with the wall control and in wireless communication with the wireless sensor.

### BACKGROUND

This disclosure relates generally to climate control systems and, more particularly, to a wireless climate control system.

Many wall controls are capable of communicating to multiple wired sensors that measure temperature for zoning purposes. However, such wall controls cannot communicate to wireless sensors.

### BRIEF SUMMARY

Disclosed is a wireless climate control system including a wall control having a user interface for controlling a plurality of climate zones. Also disclosed is a wireless sensor disposed in one of the plurality of climate zones. Further disclosed is a controller in operative communication with the wall control and in wireless communication with the wireless sensor.

In addition to one or more of the features described above, or as an alternative, further embodiments may include that the wireless communication between the controller and the wireless sensor is made with a Bluetooth Low Energy signal.

In addition to one or more of the features described above, or as an alternative, further embodiments may include that the controller converts climate data received from the wireless sensor to a simulated resistance that is communicated to the wall control.

In addition to one or more of the features described above, or as an alternative, further embodiments may include that the wireless sensor is one of a plurality of wireless sensors, each of the plurality of climate zones having at least one of the plurality of wireless sensors disposed therein.

In addition to one or more of the features described above, or as an alternative, further embodiments may include that the controller is in wired communication with the wall control.

In addition to one or more of the features described above, or as an alternative, further embodiments may include that the controller is in wireless communication with the wall control.

In addition to one or more of the features described above, or as an alternative, further embodiments may include at least one wired sensor in wired communication with the controller.

In addition to one or more of the features described above, or as an alternative, further embodiments may include that the controller is in wireless communication with a mobile device that is capable of inputting commands to the controller.

In addition to one or more of the features described above, or as an alternative, further embodiments may include that the wireless communication between the mobile device and the controller is made with a Bluetooth Low Energy signal.

In addition to one or more of the features described above, or as an alternative, further embodiments may include that the system is part of an HVAC system.

Also disclosed is a wireless climate control system including a wall control having a user interface for controlling a plurality of climate zones. Also included is at least one wired sensor disposed in at least one of the plurality of climate zones. Further included is a wireless sensor disposed in one of the plurality of climate zones. Yet further included is a controller in operative communication with the wall control, in wireless communication with the wireless sensor, and in wired communication with the at least one wired sensor, wherein the controller converts climate data received from the wired sensor to a simulated resistance that is communicated to the wall control. Also disclosed is a mobile device in wireless communication with the controller, the mobile device configured to input commands to the controller.

In addition to one or more of the features described above, or as an alternative, further embodiments may include that the wireless communication between the mobile device and the controller is made with a Bluetooth Low Energy signal.

In addition to one or more of the features described above, or as an alternative, further embodiments may include that the at least one wired sensor is one of a plurality of wired sensors, each of the plurality of climate zones having at least one of the plurality of wired sensors disposed therein.

Further disclosed is a method of wirelessly communicating data from a sensor to a wall control of a climate control system. The method includes receiving climate data with a sensor in a climate zone. The method also includes wirelessly communicating the climate data to a controller with a wireless signal. The method further includes converting the wireless signal to a simulated resistance. The method yet further includes communicating the simulated resistance to the wall control.

In addition to one or more of the features described above, or as an alternative, further embodiments may include that the wireless signal communicated from the sensor to the controller is a Bluetooth Low Energy signal.

In addition to one or more of the features described above, or as an alternative, further embodiments may include inputting commands to the controller with a mobile device in wireless communication with the controller.

### BRIEF DESCRIPTION OF THE DRAWINGS

The present disclosure is illustrated by way of example and not limited in the accompanying figures in which like reference numerals indicate similar elements.

FIG. 1 is a schematic illustration of a wireless climate control system according to an aspect of the disclosure; and

FIG. 2 is a schematic illustration of the wireless climate control system according to another aspect of the disclosure.

### DETAILED DESCRIPTION

The Figures show various embodiments of a wireless climate control system that may be employed in a structure that benefits from HVAC technology. For example, the wireless climate control system may be employed in residential or commercial buildings, typically with multiple climate control zones that are to be independently monitored or controlled. The climate control zones may be different rooms and/or floors of a structure.

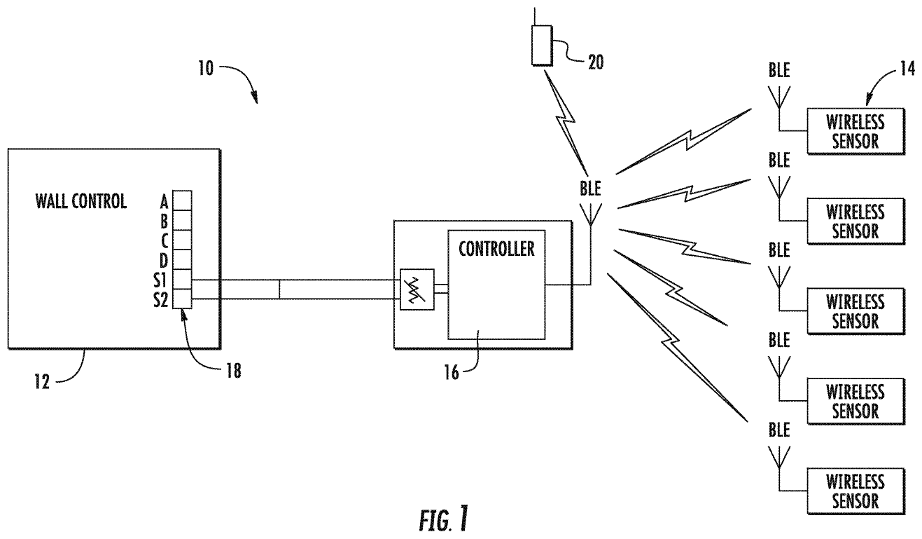

FIG. 1 illustrates an embodiment of a wireless climate control system and is generally referenced with numeral 10. The system wireless climate control system 10 includes a wall control 12, which may be referred to as a thermostat. The wall control 12 is accessible to a user as a display for showing various conditions of the wireless climate control system 10, including, for example, temperature, humidity, time, program schedule, etc., related to one or more of the climate control zones. Rather than requiring a hard wired connection with sensor(s) disposed in the climate control zones, the wireless climate control system 10 includes one or more wireless sensors 14 that are in operative communication with the wall control 12. One or more wireless sensor may be disposed in each climate control zone in some embodiments.

A controller 16 is provided as an interface that facilitates communication between the wireless sensors 14 and the wall control 12. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

The controller 16 is in wireless communication with the wireless sensors 14. In some embodiments, the wireless communication between the wireless sensors 14 and the controller 16 is provided with a Bluetooth Low Energy (BLE) signal that is transmitted from the wireless sensors 14 to the controller 16. However, it is contemplated that alternative wireless connections may be utilized to facilitate the wireless connection. Regardless of the precise wireless connection, the wireless sensors 14 obtain data in the climate control zones in which they are disposed and send climate data to the controller 16 via the wireless connection. The controller 16 is wired to one or more terminals 18 of the wall control 12 in the illustrated embodiment. However, it is contemplated that the controller 16 may be in wireless communication with the wall control 12 in some embodiments. Furthermore, the controller 16 may be part of the wall control 12 in an embedded manner in some embodiments.

The controller 16 receives the climate data from the wireless sensors 14 and converts the signal data to a simulated resistance that corresponds to, and is indicative of, an output such as temperature. This is particularly beneficial for embodiments of a wired climate control system where the wall control 12 is part of an existing climate control system that requires a hard wired connection to remote sensors that send a simulated resistance to the wall control 12. In such embodiments, the wired connection may be eliminated by retrofitting the climate control system to incorporate the controller 16 that enables the use of wireless sensors 14 that communicate with the wall control 12. The retrofit that includes the addition of the controller 16 and the wireless sensors 14 simply requires establishment of a connection between the controller 16 and the wall control 12 that substitutes the connection between the remote sensors and the wall control 12. Substituting all of the wired connections (potentially lengthy) between the remote sensors and the wall control 12 with a single connection between the controller 16 and the wall control 12 substantially reduces the wiring complexity of the overall system.

The wireless climate control system 10 advantageously allows the system to be programmed and modified wirelessly with a mobile device 20. As shown, a mobile device is in operative communication with the controller 16. The wireless connection is facilitated with a BLE signal in some embodiments.

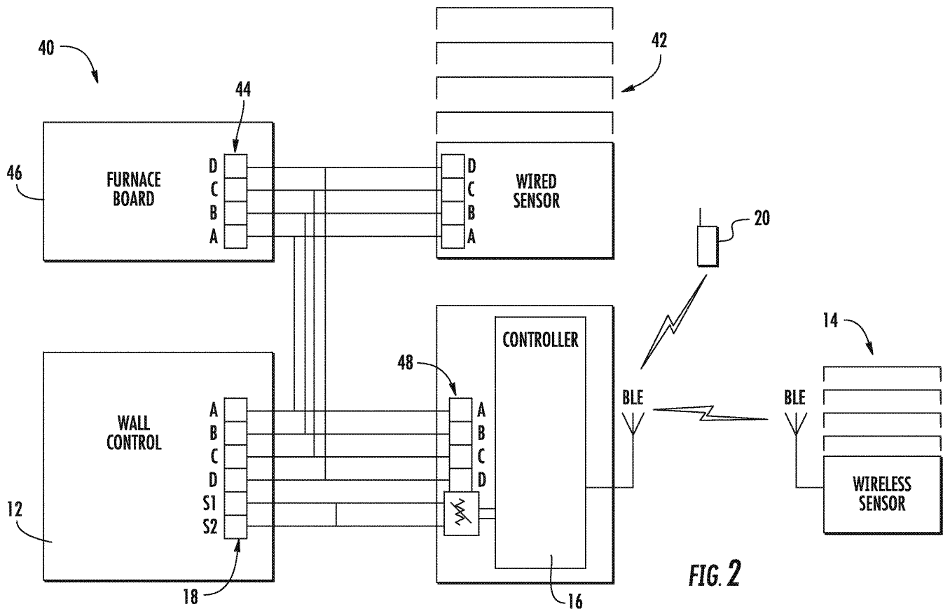

Referring now to FIG. 2, an embodiment of the wireless climate control system is illustrated and is generally referenced with numeral 40. The wireless climate control system 40 includes at least some of the above-described elements associated with the embodiments of FIG. 1, as the wireless climate control system 40 includes the wall control 12, the controller 16, the terminal(s) 18 and the mobile device 20. As illustrated and described herein, the system 40 is a combination of wired and wireless sensors, the integration of which is facilitated by the controller 16.

The wireless climate control system 40 also includes one or more wired sensors 42 that are wired to respective terminals 44 of a furnace board 46. The wired sensors 42 and the furnace board 46 are also in wired connection with terminals 48 of the controller 16. Connection to the controller 16 allows the wireless climate control system 40 to be configured to have wireless sensors 14 added to the system, if desired, in replacement of one or more remote room sensors. Remote room sensors may be used to take the place of the control's internal temperature sensor, thereby facilitating mounting in areas with less than optimal airflow (such as near an exterior door, window or in a closet), but require wiring to terminal block connectors at the control's backplate. Therefore, the signal associated with the climate data provided by the wired sensors 42 to the controller 16 are converted to a simulated resistance that corresponds to, and is indicative of, an output such as temperature. As with the embodiments of FIG. 1, the controller 16 is wired to one or more terminals 18 of the wall control 12 in the illustrated embodiment. However, it is contemplated that the controller 16 may be in wireless communication with the wall control 12 in some embodiments. Furthermore, the controller 16 may be part of the wall control 12 in an embedded manner in some embodiments.

As with the above-described embodiments, the wireless climate control system 40 advantageously allows the system to be programmed and modified wirelessly with the mobile device 20. As shown, the mobile device 20 is in operative communication with the controller 16. The wireless connection is facilitated with a BLE signal in some embodiments.

The wireless climate control system 40 is a combination of wired and wireless sensors 42, 14 that transmit climate data to a common controller 16 for communication with the wall control 12. The climate data associated with the signals is converted to a simulated resistance, as described above, for transmission to the wall control 12.

The wireless climate control system 40 advantageously allows the system to be programmed and modified wirelessly with the mobile device 20. As shown, the mobile device 20 is in operative communication with the controller 16. The wireless connection is facilitated with a BLE signal in some embodiments.

The embodiments disclosed herein allow climate control systems to incorporate wireless sensors. Additionally, existing systems may be easily retrofitted to include initial or additional wireless sensors therein.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., a processor, apparatus or system) to perform one or more methodological acts as described herein.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments have been described, it is to be understood that aspects of the disclosure may include only some of the described embodiments. Accordingly, the disclosure is not to be seen as limited by the foregoing description, but is only limited by the scope of the appended claims.

1. A wireless climate control system comprising:
a wall control having a user interface for controlling a plurality of climate zones;
a wireless sensor disposed in one of the plurality of climate zones; and
a controller in operative communication with the wall control and in wireless communication with the wireless sensor.

2. The wireless climate control system of claim 1, wherein the wireless communication between the controller and the wireless sensor is made with a Bluetooth Low Energy signal.

3. The wireless climate control system of claim 1, wherein the controller converts climate data received from the wireless sensor to a simulated resistance that is communicated to the wall control.

4. The wireless climate control system of claim 1, wherein the wireless sensor is one of a plurality of wireless sensors, each of the plurality of climate zones having at least one of the plurality of wireless sensors disposed therein.

5. The wireless climate control system of claim 1, wherein the controller is in wired communication with the wall control.

6. The wireless climate control system of claim 1, wherein the controller is in wireless communication with the wall control.

7. The wireless climate control system of claim 1, further comprising at least one wired sensor in wired communication with the controller.

8. The wireless climate control system of claim 1, wherein the controller is in wireless communication with a mobile device that is capable of inputting commands to the controller.

9. The wireless climate control system of claim 8, wherein the wireless communication between the mobile device and the controller is made with a Bluetooth Low Energy signal.

10. The wireless climate control system of claim 1, wherein the system is part of an HVAC system.

11. A wireless climate control system comprising:
a wall control having a user interface for controlling a plurality of climate zones;
at least one wired sensor disposed in at least one of the plurality of climate zones;
a wireless sensor disposed in one of the plurality of climate zones;
a controller in operative communication with the wall control, in wireless communication with the wireless sensor, and in wired communication with the at least one wired sensor, wherein the controller converts climate data received from the wired sensor to a simulated resistance that is communicated to the wall control; and
a mobile device in wireless communication with the controller, the mobile device configured to input commands to the controller.

12. The wireless climate control system of claim 11, wherein the wireless communication between the mobile device and the controller is made with a Bluetooth Low Energy signal.

13. The wireless climate control system of claim 11, wherein the at least one wired sensor is one of a plurality of wired sensors, each of the plurality of climate zones having at least one of the plurality of wired sensors disposed therein.

14. A method of wirelessly communicating data from a sensor to a wall control of a climate control system, the method comprising:
receiving climate data with a sensor in a climate zone;
wirelessly communicating the climate data to a controller with a wireless signal;
converting the wireless signal to a simulated resistance; and
communicating the simulated resistance to the wall control.

15. The method of claim 14, wherein the wireless signal communicated from the sensor to the controller is a Bluetooth Low Energy signal.

16. The method of claim 14, further comprising inputting commands to the controller with a mobile device in wireless communication with the controller.
